(19) United States
(12) Patent Application Publication
(10) Pub. No.: US 2018/0015870 A1
(43) Pub. Date: Jan. 18, 2018

(54) ANTI-THEFT INTEGRATED ATTACHMENT SYSTEM

(71) Applicant: FORD GLOBAL TECHNOLOGIES, LLC, Dearborn, MI (US)

(72) Inventors: Jorge Manuel Rodriguez Vazquez, Atizapan de Zaragoza (MX); Jonatan Leff Yaffe, Mexico City (MX); Carlos Emilio Merino, Benito Juarez (MX); Pedro Montoya, Mexico City (MX)

(21) Appl. No.: 15/210,456

(22) Filed: Jul. 14, 2016

(51) Int. Cl. B60Q 1/20; B60Q 1/04; B60R 19/52; B60R 25/00

(52) U.S. Cl. CPC B60Q 1/20; B60R 25/00; B60Q 1/0408; B60R 19/52

(57) ABSTRACT

An attachment system for a removable vehicle component includes a fixed fastener associated with a first element, a cooperating receiver associated with a second element, and an aperture or port configured for providing access to the fixed fastener. The first element may be one of a vehicle fascia or a removable vehicle component, and the second element may be another of the vehicle fascia or the removable vehicle component. Vehicle fascia assemblies and methods of attaching a removable component to a vehicle fascia using the attachment system are described.

### TECHNICAL FIELD

This disclosure relates generally to automotive components, and more particularly to an attachment system for fascia-mounted automotive component assemblies.

### BACKGROUND

A variety of components and assemblies are attached to a vehicle, and in particular are attached to a vehicle fascia. Components/assemblies which do not require periodic service or inspection/replacement have the advantage that they can be attached to the B-side of the fascia using a variety of “hard” fasteners such as bolts, screws, speed nuts, lock nuts, and others. Often, removal of such components requires special tools, complete or partial removal of the fascia, or both.

However, other components/assemblies typically attached to a vehicle fascia require periodic service, i.e. removal, inspection, and/or replacement of portions or entireties thereof. Such service-requiring components/assemblies that are attached to vehicle fascia include, without intending any limitation, features such as fog lamps and fog lamp assemblies which must be attached to the fascia in a manner providing easy accessibility for removal, service, etc. Conventionally such service-requiring components/assemblies are attached to the fascia by fasteners other than hard fasteners, for example by clips, friction/interference fittings, snap fittings, and other easily accessible and disengageable fasteners which do not require special tools and which can be accessed without need of full or partial fascia removal. Often, such components/assemblies requiring service are configured for easy removal by hand. While such easily accessible and removable component configurations provide convenience in repair and replacement, they also increase theft risk.

To solve these and other problems, the present disclosure relates to an integrated attachment system for fascia-mounted components and other components. Advantageously, the described attachment system allows easy access for installation/uninstallation of a component using simple tools, without any need of fascia removal/disassembly.

### SUMMARY

In accordance with the purposes and benefits described herein, in one aspect of the present disclosure an attachment system for a removable vehicle component is described, comprising a fixed fastener associated with a first element, a cooperating receiver associated with a second element, and an aperture or port configured for providing access to the fixed fastener.

In embodiments, the first element is a vehicle fascia and the second element is a removable vehicle component. In other embodiments, the first element is a removable vehicle component and the second element is a vehicle fascia.

In another aspect, a vehicle fascia assembly is described, comprising a fascia defining one or more receivers and a removable component dimensioned to be received in a one of the fascia receivers. A fixed fastener is associated with one of the fascia or the removable component, and a cooperating receiver is associated with another of the fascia or the removable component. An aperture or port is disposed in the fascia, configured for providing access to the fixed fastener.

In embodiments, the fixed fastener is a floating screw or a captive screw. In embodiments, the removable component is selected from the group consisting of a fog lamp, a fog lamp assembly, a bezel for a fog lamp assembly, a fog lamp cover, a fog lamp delete cover, a daytime running light assembly, and others.

In yet another aspect, a method for attaching a removable component to a vehicle fascia is provided, comprising providing a fixed fastener associated with one of a vehicle fascia or a removable component and providing a cooperating receiver associated with another of the vehicle fascia or the removable component. Next are steps of aligning the removable component and the vehicle fascia whereby the fixed fastener and cooperating receiver are aligned, and attaching the fixed fastener to the cooperating receiver. The fixed fastener may be accessed via an aperture or port defined in the vehicle fascia. The aperture or port may be provided defined in a bottom surface of the vehicle fascia.

In embodiments, the fixed fastener is provided associated with one of the vehicle fascia or the removable component and the cooperating receiver is provided associated with another of the vehicle fascia or the removable component. In embodiments, the removable component is provided selected from the group consisting of a fog lamp, a fog lamp assembly, a bezel for a fog lamp assembly, a fog lamp cover, a fog lamp delete cover, a daytime running light assembly, and others. In embodiments, the fixed fastener is provided as a floating screw or a captive screw.

In the following description, there are shown and described embodiments of the disclosed integrated attachment system for fascia-mounted components. As it should be realized, the system is capable of other, different embodiments and its several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed integrated attachment system for fascia-mounted components, and together with the description serve to explain certain principles thereof. In the drawing:

FIG. 1 depicts a removable fog lamp assembly attached to a vehicle fascia;

FIG. 2 depicts an attachment system for a removable vehicle component according to the present disclosure; and

FIG. 3 depicts an embodiment of a fixed fastener for use with the attachment system of FIG. 2.

Reference will now be made in detail to embodiments of the disclosed integrated attachment system for fascia-mounted components, examples of which are illustrated in the accompanying drawing figures.

### DETAILED DESCRIPTION

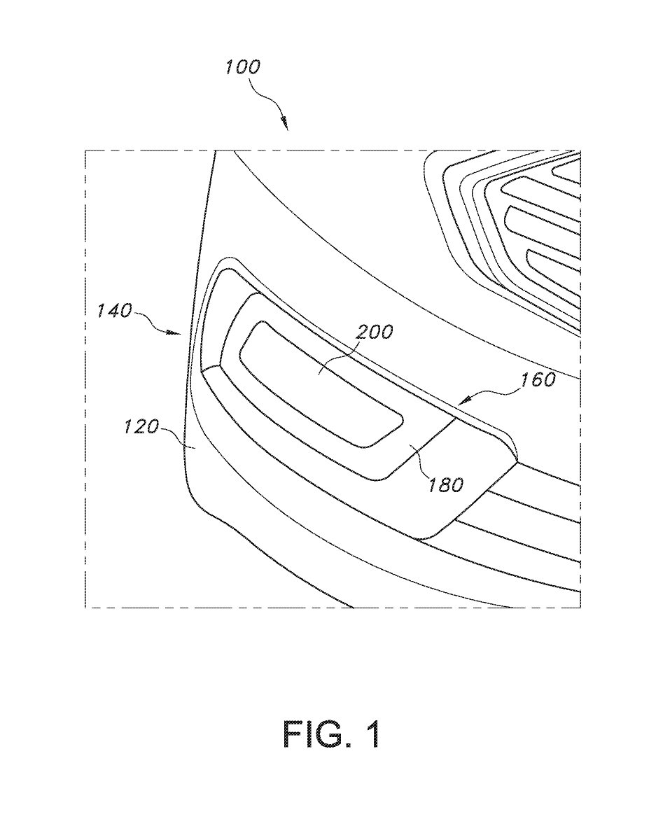

FIG. 1 illustrates a vehicle 100 including a front fascia 120 having a component 140 attached thereto, in the depicted embodiment being a fog lamp assembly 160 including a bezel 180 and a lamp 200. Conventionally, the fog lamp assembly 160 is attached to the fascia 120 in a manner such that it is easily removable by service personnel, but also unfortunately by thieves. Alternatively, securing such assemblies using hard fasteners at a B-side of the fascia 120 reduces serviceability, requiring complete or partial removal of the fascia to allow inspection and/or repair/replacement.

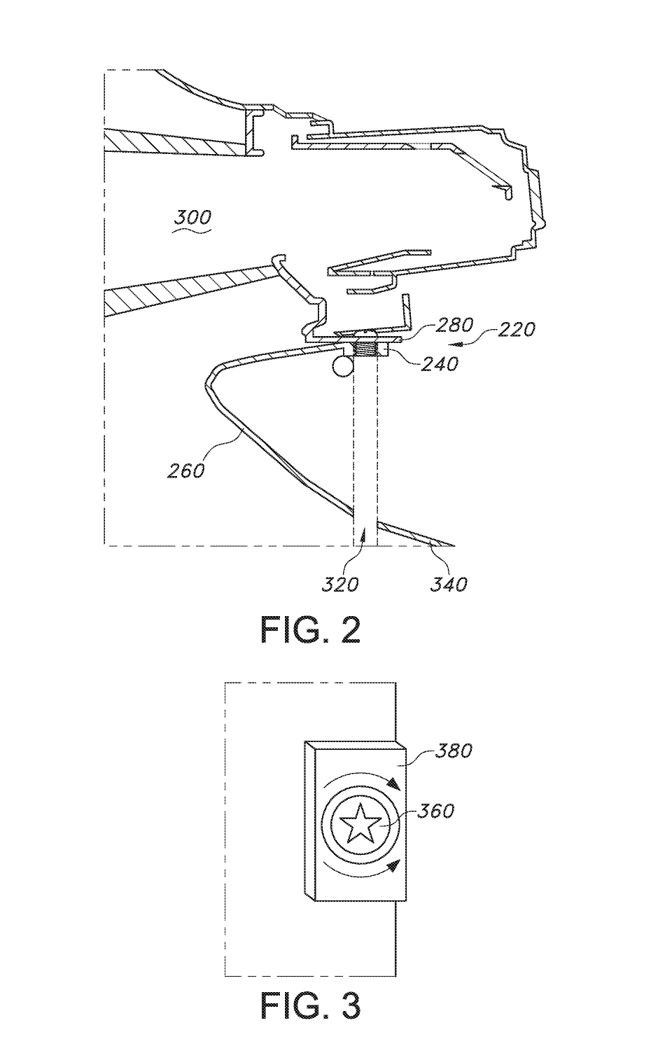

To solve this and other problems, with reference to FIG. 2 an attachment system 220 is provided, comprising a fixed fastener 240 associated with a vehicle element 260 and a mating receiver 280 associated with a removable component 300. The attachment system 220 further may include a service access aperture or port 320 allowing easy access to the fixed fastener 240 to install or remove the removable component 300 using simple tools.

In the embodiment depicted in FIG. 2, the fixed fastener 240 is associated with a vehicle element 260 that is a vehicle front fascia. In turn, the mating receiver 280 is associated with a removable component 300 that in the depicted embodiment is a fog lamp assembly bezel. However, it will be readily appreciated that the converse arrangement is equally suitable, i.e. the fixed fastener 240 associated with a removable component 300 and the mating receiver 280 associated with the vehicle element 260.

In turn, it will readily be appreciated that the fixed fastener 240 may be associated with other vehicle elements, including a fascia lower valance, an exposed bumper beam, and others. In turn, the described attachment system 220 is contemplated for use in fastening other vehicle components, for example fog lamp covers, fog lamp delete covers, daytime running light assemblies, or any such exterior component requiring periodic removal for inspection, repair and/or replacement.

The service access aperture or port is disposed in a bottom surface 340 of the vehicle element 260, which as will be appreciated improves ease of access for service personnel using a lift or other such device, but makes access for individuals with nefarious intent more difficult.

In one possible embodiment (see FIG. 3), the fixed fastener 240 is a floating screw of known design, being a screw 360 loosely captured within a holder 380 whereby it cannot be displaced therefrom but can still be rotated to engage a mating receiver 280. Thus, a user need only place the removable component 300 in place in or on the vehicle element 260 whereby the fixed fastener 240 and mating receiver 280 are substantially aligned. Then, the user only has to access the fixed fastener using a tool of suitable length and configuration such as a screwdriver, and engage the mating receiver 280 with the fixed fastener 240 to attach the removable component 300 to the vehicle element 260. Of course, other types of fixed fastener 240 are contemplated, including as a non-limiting example a captive screw, a floating bolt, a captive bolt, and others.

As will be appreciated, by the above-described attachment system 220 an effective attachment system is provided for vehicle components requiring periodic servicing and/or replacement. Advantageously, by use of the described system serviceability of fascia-mounted components is markedly improved, while concurrently reducing risk of theft. In turn, by use of the system such components can be attached to the fascia using hard fasteners, thus increasing security of the attachment. Still more, the described system is simple and robust, and does not require additional brackets or other parts which increase manufacturing complexity and cost.

Obvious modifications and variations are possible in light of the above teachings. All such modifications and variations are within the scope of the appended claims when interpreted in accordance with the breadth to which they are fairly, legally and equitably entitled.

What is claimed:

1. An attachment system for a removable vehicle component, comprising:
a fixed fastener associated with a first element;
a cooperating receiver associated with a second element; and
an aperture or port configured for providing access to the fixed fastener.

2. The system of claim 1, wherein the first element is a vehicle fascia and the second element is a removable vehicle component.

3. The system of claim 1, wherein the first element is a removable vehicle component and the second element is a vehicle fascia.

4. The system of claim 1, wherein the fixed fastener is a floating screw or a captive screw.

5. The system of claim 2, wherein the removable vehicle component is selected from the group consisting of a fog lamp, a fog lamp assembly, a bezel for a fog lamp assembly, a fog lamp cover, and a fog lamp delete cover.

6. The system of claim 3, wherein the removable vehicle component is selected from the group consisting of a fog lamp, a fog lamp assembly, a bezel for a fog lamp assembly, a fog lamp cover, and a fog lamp delete cover.

7. A vehicle including the system of claim 1.

8. A vehicle fascia assembly, comprising:
a fascia defining one or more receivers;
a removable component dimensioned to be received in a one of the one or more receivers;
a fixed fastener associated with one of the fascia or the removable component;
a cooperating receiver associated with another of the fascia or the removable component; and
an aperture or port disposed in the fascia and configured for providing access to the fixed fastener.

9. The assembly of claim 8, wherein the fixed fastener is a floating screw or a captive screw.

10. The assembly of claim 8, wherein the removable component is selected from the group consisting of a fog lamp, a fog lamp assembly, a bezel for a fog lamp assembly, a fog lamp cover, and a fog lamp delete cover.

11. A vehicle including the assembly of claim 8.

12. A method for attaching a removable component to a vehicle fascia, comprising:
providing a fixed fastener associated with one of a vehicle fascia or a removable component;
providing a cooperating receiver associated with another of the vehicle fascia or the removable component;
aligning the removable component and the vehicle fascia whereby the fixed fastener and cooperating receiver are aligned; and
attaching the fixed fastener to the cooperating receiver.

13. The method of claim 12, including accessing the fixed fastener via an aperture or port defined in the vehicle fascia.

14. The method of claim 13, including providing the aperture or port defined in a bottom surface of the vehicle fascia.

15. The method of claim 12, including providing the fixed fastener associated with one of the vehicle fascia or the removable component.

16. The method of claim 15, including providing the cooperating receiver associated with another of the vehicle fascia or the removable component.

17. The method of claim 12, including selecting the removable component from the group consisting of a fog lamp, a fog lamp assembly, a bezel for a fog lamp assembly, a fog lamp cover, and a fog lamp delete cover.

18. The method of claim 12, including providing a floating screw or a captive screw as the fixed fastener.
